(19) United States
(12) Patent Application Publication
(10) Pub. No.: US 2021/0326961 A1
(43) Pub. Date: Oct. 21, 2021

(54) METHOD FOR PROVIDING BEAUTY PRODUCT RECOMMENDATIONS

(71) Applicant: Tariro Audrey Kandemiri, Atlanta, GA (US)

(72) Inventor: Tariro Audrey Kandemiri, Atlanta, GA (US)

(21) Appl. No.: 17/232,071

(22) Filed: Apr. 15, 2021

Related U.S. Application Data
(60) Provisional application No. 63/010,120, filed on Apr. 15, 2020.

(51) Int. Cl. G06Q 30/06

(52) U.S. Cl. CPC G06Q 30/0631; G06Q 30/0641

(57) ABSTRACT

A system for providing beauty product recommendations can receive user-specific values for beauty characteristics of certain beauty characteristic types specified by a recommendation service that is implemented on a user device and supported by a backend. The backend can identify product results from matches of between beauty characteristic values for first and second characteristic types and product data included in product user review information. The first and second characteristic types maybe selected from a group including skin tone, age, and skin type beauty characteristic types. Confidence scores can be determined for products in the products results according to weighted values for the identified matches, and the system can cause scored product results to display in a user interface based on the confidence scores.

### BACKGROUND

Beauty products are used all around the world by individuals to change or enhance physical appearance. Beauty products applied to an individual's face, for example, are known generally in the industry as makeup. When shopping for beauty products and makeup, it is easy for a person to become overwhelmed by the countless number and types of available product options. This can include, but is not limited to, products such as moisturizers, primers, serums, foundations, lip products, eye shadows, concealers, mascaras, eyeliners, etc. Individuals shopping for beauty products often spend hours browsing store shelves or retailer websites, only to ultimately purchase a product that is not a match for their needs.

When an individual obtains a product that is not a good fit for their specific needs, they are dis-satisfied, now own one or more unusable products, and have, in effect, wasted a portion of their income. Wasted income is especially an issue for higher tier beauty products that come at very high price points and may be convincingly advertised as absolutely perfect products. Individuals often make uniformed purchases of beauty products based on an immediate need. Conversely, in order to inform themself, an individual may conduct hours of research in different places in an effort to identify crucial information about the products. Neither situation yields good and reliable results because these individuals do not have an ability to compare and contrast beauty products from different brands in one place.

In-store (e.g., face to face) purchases of beauty products pose additional issues. In-store sales associates at beauty product stores are not always well versed in the product needs for various individuals having different skin types and skin tones. Additionally, in-store associates are often compensated according to a commission structure that rewards the associates a percentage of their total beauty product sales. Thus, there compensation is volume-based and effectively encourage these associates to push products on individuals without an emphasis on finding beauty products that are well suited to each individual's specific beauty characteristics (e.g., age, skin tone, skin type, pigmentation type). As result, individuals shopping in stores for beauty products often feel pressured and are disappointed because they are not provided meaningful and sincere assistance tailored to their needs. Further, they often leave stores either empty-handed or with beauty products that will ultimately prove to be a waste of their money because those beauty products are not a good fit for their needs.

Existing systems geared toward assisting individuals select beauty products are flawed as they do not help a user make informed and accurate decisions that work best for that user's specific needs. Currently, product information available to individuals (via, e.g., websites, dedicated applications, web applications, email advertisements, etc.) regarding various beauty products may include reviews from other users that have purchased those beauty products. However, there currently does not exist a system that can be used to narrow down thousands of reviews in a user-friendly, let alone user-specific, manner. There does not exist a system that filters products based on a user's specified skin needs (such as “hydration” or “sensitive skin”) using these thousands of product reviews. Current systems and services do not allow individuals to narrow products down utilizing keyword inputs within the context of these product reviews and product details. These systems and services do not allow individuals to craft their own custom list of wants and needs. Additionally, these systems and services may request individuals answer large numbers of questions that are irrelevant to the needs of these individuals at any specific moment. As a result, these individuals in need of beauty products do not have an ability to receive a fast and effective beauty product recommendation.

As a result, a need exists for a systems and methods for providing beauty product recommendations that are tailored to the specific beauty characteristics, such as age demographic, skin tone, skin type, desired effect or look, of an individual attempting to obtain a beauty product that optimally meets that individual's needs.

### SUMMARY

Examples described herein include systems and methods for providing beauty product recommendations based on millions of demographic data points.

In one example, a system for providing beauty product recommendations can receive user-specific values for beauty characteristics of certain beauty characteristic types specified by a recommendation service that is implemented on a user device and supported by a backend. The backend can identify product results from matches of between beauty characteristic values for first and second characteristic types and product data included in product user review information. The first and second characteristic types maybe selected from a group including skin tone, age, and skin type beauty characteristic types. Confidence scores can be determined for products in the products results according to weighted values for the identified matches, and the system can cause scored product results to display in a user interface based on the confidence scores.

The systems and methods described herein can assist individuals overwhelmed with the myriad of options for makeup and beauty products and looking for assistance to find great products that work for other individuals of their particular age and have their particular skin tone, and skin type. The systems and methods described herein can provide individuals with a beauty product recommending salutation that shares purchasing options from a wide range of beauty retailers tailored to specified consumer needs. A backend of the system described herein can perform complex and detailed searching to allow an individual to enjoy a secure and helpful shopping process without having to wade through multiple and confusing information sources.

Systems and methods described herein can be used by individuals who can enter their age demographic information and skin needs, which are then matched to details provided in product data which encompass product reviews from a multitude of data sources across the web. In turn the systems and methods described herein can provide product recommendations that are likely to work best for individuals having specific needs. Confidence scores for these recommendations can be calculated based on a number of factors and thereby represent potential accuracy of these recommendations as to an individual's specific beauty product needs. Focus on the product reviews a source of matches with specific beauty characteristic values provided by individuals tends to embody a “wisdom of the crowd” type of approach that advantageously allows individuals to receive customized and specific product recommendations based on input of other individuals around the world in an instant, lessening the burden of having to choose products on their own or purchasing a product that is not aligned with their needs.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is a flowchart of an example method for providing beauty product recommendations.

FIG. 2A is a sequence diagram of an example method for identifying a product library for providing beauty product recommendations.

FIG. 2B is a sequence diagram of an example method for determining and displaying confidence scores for beauty product recommendations.

FIG. 3 is an algorithmic flowchart of an example method for identifying a product library based on a credential associated with a recommendation service.

FIG. 4 is an illustration of exemplary system components for providing beauty product recommendations.

FIG. 5 illustrates an exemplary interface for accessing a recommendation service, according to an aspect of the present disclosure.

FIG. 6 illustrates an exemplary interface for a recommendation service, according to an aspect of the present disclosure.

FIG. 7 illustrates an exemplary interface for a display product results determined by a recommendation service.

FIG. 8 illustrates an exemplary interface for viewing a single result selected from a product results interface.

FIG. 9 illustrates an exemplary interface for viewing saved beauty products.

FIG. 10 illustrates an exemplary interface for viewing beauty products.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

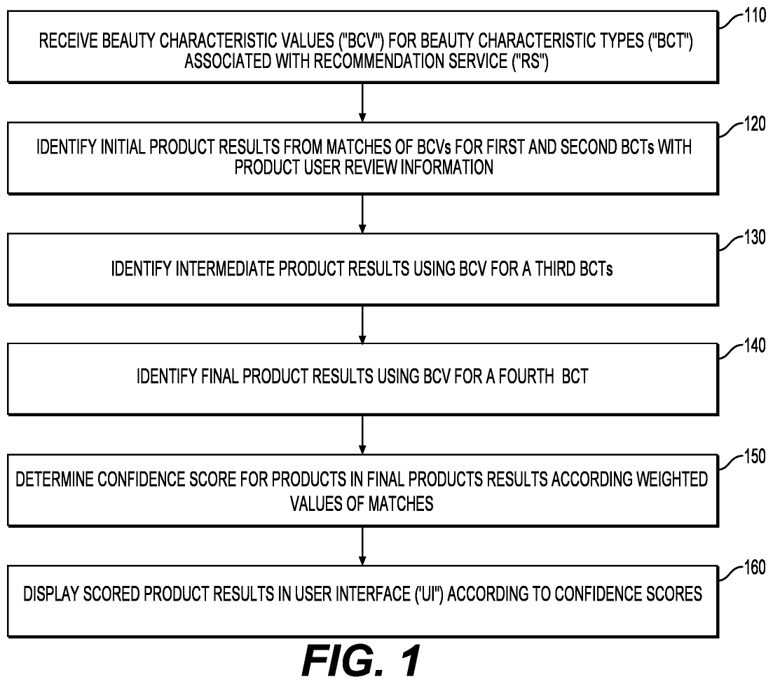

FIG. 1 is a flowchart of an example method for providing beauty product recommendations. FIG. 1 broadly illustrates processes performed on a backend to provide beauty product recommendations by using a graduated evaluation of product data using user-specific beauty characteristics that may include skin tone, skin type (e.g., dry, oily, etc.), pigmentation type (e.g., homogenous pigmentation, hyperpigmentation), and age, as well as user-defined criterion. This user-defined criterion can include any feature desired or criteria for filtering that a user wishes to include as a limiting factor for the beauty product recommendations that user receives. Product data including consumer product reviews can be maintained in a centralized or diversified database. Beauty characteristic values can be parsed based on product details or categories of product detail encompassed by an entirety of product data maintained by the product database. As will be explained in more detail with reference to the stages of the method of FIG. 1, the method provides product recommendations of products that are accurately tailored to physical characteristics and preferences of individual users.

In stage 110, receive beauty characteristic values (“BCV”) for beauty characteristic types (“BCT”) associated with a recommendation service. In example, an exemplary system that executes or otherwise implements the method of FIG. 1, can include a backend. The backend can maintain, execute, or otherwise implement different services that process input received from a recommendation service being delivered to a user through a user interface.

In one example, a user interface may be embodied as a website, a web application, or a dedicated application being executed on a user device. A user device can be provided by any computing device such as a mobile phone, laptop, computer, tablet, or the like, that includes one or more processors and memory storage locations. More generally, a computing device that serves as a user device may include any processor-enabled device that one or more memory stores, one or more storage locations, and one or more processors configured to execute instructions accessible from a non-transitory, computer-readable medium by the one or more processors.

In one example, a user interface in which a version of a recommendation service is implemented, may be supported, updated, managed, and otherwise maintained by a backend. In another example, the user interface may be supported, updated, managed, and otherwise maintained by a third-party, such as a beauty product provider that manufactures and sells beauty products. In this example, a content server associated with the third-party may support, update, manage, or otherwise maintain the user interface. A version of a recommendation service can be delivered through this third-party user-interface based on a configuration that is set by the backend, and the backend can provide the content server with content, process inputs, and deliver outputs according to that configuration. In one example, along with content, the backend can include instructions for delivering the recommendation service with the third-party user interface.

In yet another example, the version of the recommendation service delivered on the third-party user interface may be implemented directly by a management service for the backend. In this example, a content server can serve as a pass-through that transmits calls (e.g., application programing interface calls) from the recommendation service as requests for the recommendation service are received through the third-party user interface.

Thus, a user interface may include a website, web application, or dedicated application that is directly associated with the backend. This type of backend-maintained user interface may deliver a version of a recommendation service having unrestricted access to the beauty product details, reviews, prices, compositions, and other product-related information (hereafter referred to as “beauty product data”) managed by the backend. In another example, the user interface may be associated with a beauty product provider, supported by a content server or other non-backend system or platform. In this example, the user interface may deliver a version of the recommendation service that is: (A) supported by the backed either directly or through the content server, and (B) has restricted access to the beauty product data. More specifically, this version of the recommendation service may be restricted to beauty product data only for beauty products of that beauty product provider. The scope and volume of product data associated with the version of the recommendation service being delivered therefore constitutes a product library from which products will be identified based on the BCVs that are received in stage 110.

In one example, the BCTs can include age, skin type, skin tone, and skin pigmentation type. In addition, the recommendation service may include a field in which a desired feature or keyword BCT value can be entered by a user.

Values for the age BCT can be received at a single number or as a selectin of an age range. In one example, the different selectable age ranges can include ranges such as 13-17 years, 18-24 years, 25-34 years, 35-44 years, 45-54 years, and an over 54 years range. It will be understood that these ranges are exemplary and may be different in different implementations of a recommendation service. For example, a version of the recommendation service that is deployed on a user interface that is maintained by a third-party that sells beauty products that are suited towards older individuals, may only include ranges that being at 44 years of age.

For a skin tone BCT, a user may be presented with a pallet of different colors that correspond to different skin tones. The user may select the skin tone that best matches their own skin tone by selecting one of the color/tone options displayed. The number of color/tone options can vary depending on a version of a recommendation service being delivered through the user interface. In one example, a user may be able to select from 23 different color/tone options. In some examples, selectable values for age and skin type BCTs can include All ages and all skin types.

In some examples, the recommendation service can include a skin pigmentation BCT. Selectable values for this BCT may include hyperpigmentation or homogenous pigmentation. Further, in some examples where a user selects the hyperpigmentation value, multiple skin tone BCT sections may be displayed on the user interface such that the user can select the different skin tones that user believes they present as a result of their hyperpigmentation.

In addition to the BCTs discussed above, the recommendation service may present a desired/feature or keyword BCT in the form of a field where a user can enter text. In this example, the user may enter words that pertain to specific features they desire from a beauty product, area of the body, kind of assistance they may need to select beauty products, and/or what areas or conditions they would like product recommendations (i.e., hydration, shine, sensitive skin, etc.) to be focused on addressing.

In various examples, which of the BCTs displayed in the user interface can depend on a level of permissions provided by the backend configuration for the version of the recommendation service being delivered by a user interface. In some examples, a party responsible for the backend or otherwise responsible for providing the various versions of the recommendation service to third parties, may have different agreements with those third parties. As a result, a number and types of BCTs that a version of a recommendation service presents may be different for different user interfaces.

At stage 120, initial product results can be identified from a product library of product data associated with the version of the recommendation service delivered through the user interface. These initial product results may correspond to matches between: (A) BCVs for first and second BCTs, and (B) product user review information included in the product library.

A match for the purposes of this and other stages described herein may include, but is not limited to, a one-to-one relationship between a BCV and an instance of data that is part of a description of a product included in a product database. Matches can be identified from instances of data that correspond to other names that are commonly understood to mean the same thing for a beauty characteristic that a BCV represents. In other examples, a match can include a partial match between a BCV and an instance of data included as part of the product data for a specific product listed or otherwise represented in the product database.

The first and second BCTs may include two from a group of BCTs that includes age, skin type, and skin pigmentation. In one example, a selection and scoring service for the backend can process the BCVs for the first and second BCTs and identify certain products from the product library that include some product data that matches one or both of the BCVs. Such a selection and scoring service can be an internal software-based tool implemented on a server encompassed by the backend. In one example, the product reviews for all the products included in a product database for the backend may include age of the individuals that provided the reviews. As result, the selection and scoring service can focus this search on the product reviews for identifying matches with the BCVs.

In stage 130, identify intermediate product results using a BCV for a third BCT. In one example, the BCT in stage 130 can be skin tone. As a result, the backend can narrow the initial product results down to an intermediate group of results based matches between the skin tone BCV received and product data for products included in the initial product results. The selection and scoring service may prioritize matches that come from product reviews in one example. In other examples, matches that come for specific fields common or substantially common to the product data for all the products included in the product library can be prioritized.

At stage 140, the selection an scoring service for the backend can identify final product results using a BCV for a fourth BCT to find matches within the product data of the products in the in the intermediate product results. In one example, the fourth BCT can correspond to a desired feature or keyword characteristic type presented in the user interface. Accordingly, the selection and scoring service can parse through product data for the products in the intermediate product results to identify those products that in include a feature or keyword entered by a user in stage 110. In one example, multiple BCVs can be received for the fourth BCT, meaning a user may input more than one desired feature or personal characteristic (e.g., hydration, hyperpigmentation, skin sensitivity, degree of shine, etc.).

Stages 120, 130, and 140 embody a decision tree that correlates attributes for different product types and merchants, as represented by product data associated with those products in a product database, to BCVs to determine matches between product details and the user provided and user-specific BCVs.

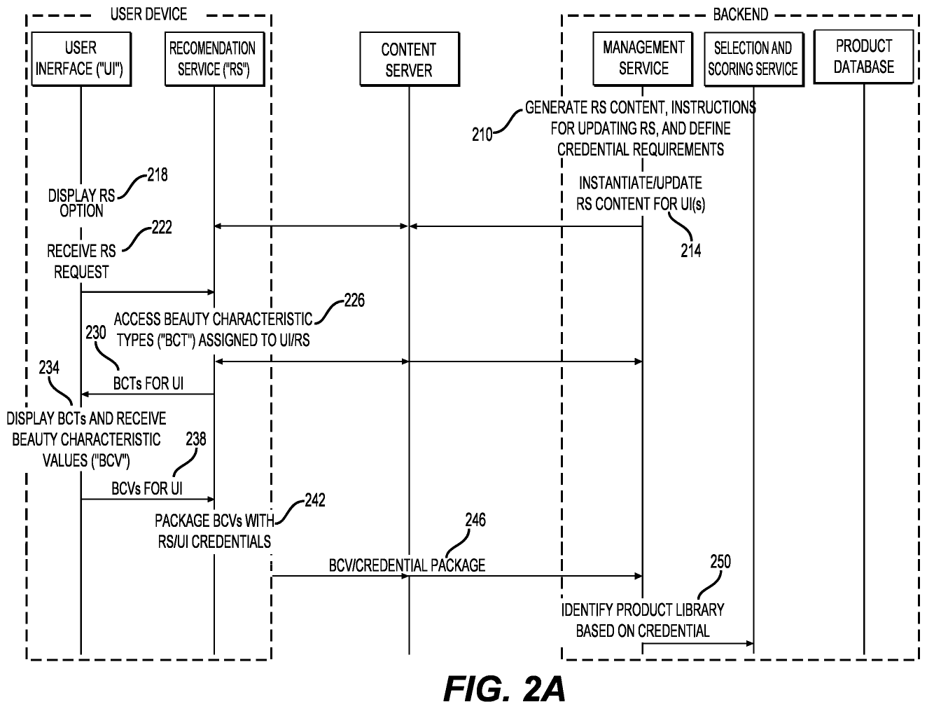

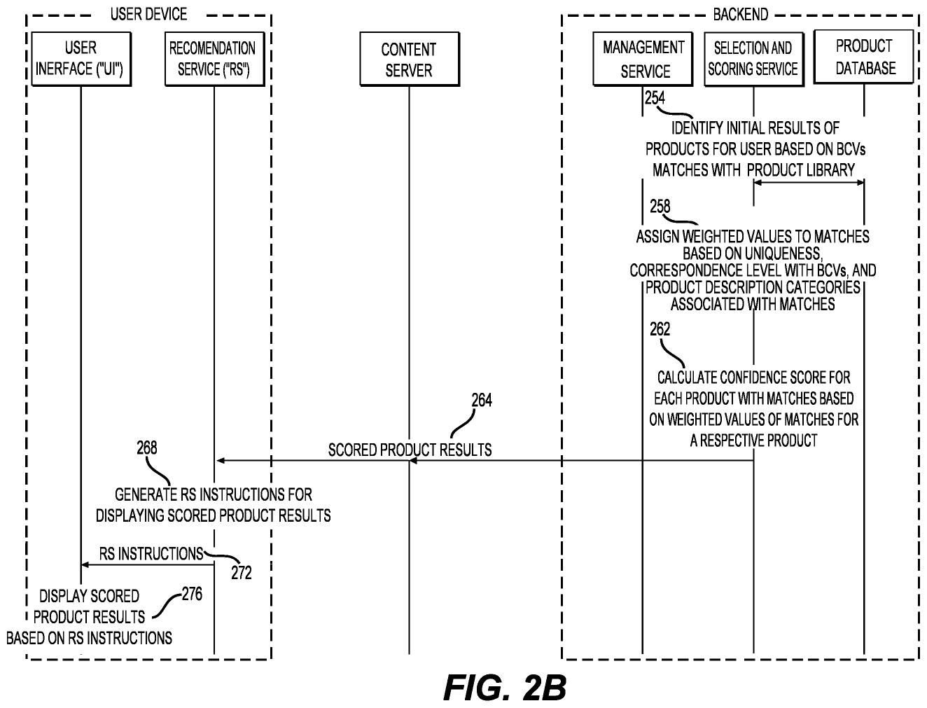

In stage 150, the backend can determine confidence scores for products in the final products results according to weighted values of matches identified. As described in more detail below and with respect to stage 258 of the exemplary method of FIG. 2B, the backend can assign weighted values to matches based on correspondence levels (e.g., one-to-one, partial, synonym match) with BCVs, and product data categories (e.g., product details, product reviews, product ratings, product types) associated with those matches.

At stage 160, the scored product results can be displayed in the user interface. In one example, these product results can be arranged relative to each other according to their respective confidence scores.

An exemplary implementation of stage 150 of the method of FIG. 1 follows to illustrate various features and as aspects thereof. A confidence score may be calculated as follows: for each value input by a user for the desired feature/keyword BCT that a user inputs, each valve may be put into a string. The selection and scoring service then analyzes product data from the product library, initial product results, intermediate product results, or the final product results previously described, and determines how many products include the string in each's respective product data. So, if for example “hyperpigmentation,” is identified in product data for 10% of products, it is more likely that those products are a match given the uniqueness of that value. As a result, those products that have a higher confidence score and appear closer to a first position in user's recommended products displayed in stage 160. On the other hand, if product data from more than 50% of the products include a value, for example “redness,” the selection and scoring service determines this value does not correspond to a unique attribute that to be factored into, or heavily weighted, for the purposes of determining a confidence score for any one product that included that value.

FIG. 2A is a sequence diagram of an example method for identifying a product library for providing beauty product recommendations.

In stage 210, a management service can generate recommendation service content, instructions for updating a recommendation service, and define credential requirements used to identify product libraries. The management service can be an internal software-based tool implemented on the backend to manage the backend operations and software and/or hardware-based tools for backend.

At stage 214, the management service can instantiate or update recommendation content for the recommendation service being implemented on a user device and delivered by a user interface. More specifically, in stage 218, the user interface can display an option for accessing a recommendation service.

At stage 222, a request for the recommendation service can be receive by the user interface and process by the recommendation service. As a result of the request, in stage 226, the recommendation service can access beauty characteristic types (“BCT”) assigned to it as a version of a recommendation service that is configured by the backend according to the user interface that delivers the recommendation service, meaning delivery of the functionality of the recommendation service, to a user requesting it. Thus, in one example, the BCTs that are accessed are included by the backend for a configuration of that version of a recommendation service being delivered/displayed on the user interface in stages 218 and 222.

At stage 230, the BCTs are transmitted for display in the user interface. In stage 234, the BCTs are displayed and beauty characteristic values (BCV) are received through the user interface.

The BCVs are transmitted to the RS in stage 238, and then packaged with a credential associated with that version of the recommendation service and/or the user interface in stage 242. At stage 246, the package is transmitted to the management service on the backend. How the package is transmitted can depend upon whether the versions of the recommendation service and user interface are maintained by the backend and provided with unrestricted access to the product data included in a product database for the backend. In other examples, for instance where the user interface is maintained by a content server employed by a third party beauty product provider, the package may first be transmitted to the content server. From the content server, the package may then be transmitted to the management service or the backend generally.

In stage 250, the management service identifies a product library within a product database maintained, or otherwise accessed by, the backend based on the credential included in the package.

FIG. 2B is a sequence diagram of an example method for determining and displaying confidence scores for beauty product recommendations.

At stage 254, a scoring and selection service can identify initial results of products for user based on BCVs matches product data for products included in the product library identified in stage 250.

The scoring and selection service can be an internal software-based tool implemented on the backend to be managed by the management service, which manages backend operations and its associated tools as previously mentioned. In another example, the scoring and selection service can be provided by the management service.

In stage 258, the selection and scoring service can assign weighted values to matches based on correspondence level with BCVs and product description categories associated with the matches.

In stage 258, the selection and scoring service can implement one or more language processors that recognize stop or ignore portions of values in place. Thus, in the process of processing a BCV, the selection and scoring service may ignore words like “the” that may be ubiquitous and are commonly understood to not be unique.

In some examples, the version of the recommendation service delivered on the user interface can provide a user with flexibility by allowing users to search for products based on their selection of a group of BCTs that is a sub-group of all the BCTs presented by/available through that version of the recommendation service. For example, the user may desire to only search products with a certain value for only one BCT (i.e., only age range, only skin type, only skin tone, or only desired feature/keywords).

The selection and scoring service takes into account all input received through the recommendation service, and identifies matches with age demographic information, skin tone and skin type-related data, and other product information included in product data that is pulled from millions of data sources. More specifically collected product data categorized as product descriptions, general information, and product reviews for all products included in the product database, can be mined for matches with the BCVs received in stage 246.

Also in stage 258, the selection and scoring service can identify or returns product recommendations based on mentions, or otherwise instances of product data, and are matched to BCVs that represent key, user specific, and skin specific features that users desire beauty products to exhibit. In addition, by focusing on product review product data, a user may be able identify beauty products well-suited for them as reflected by the information provided by reviewers of similar age range and/or having similar skin types, skin tones, and desired features. This being in addition to matches identified from product data included in or otherwise considered to be of overall description product data category.

The selection and scoring service can assign weighted values to the identified matches based on: uniqueness of the BCVs associated therewith; a correspondence level of the match between the BCV and the matched product data (e.g., one-to-one, partial match, synonym match); and product data categories associated with the matches (e.g., product details, product review, product description). As a result of this weighting system, the selection and scoring service can alert users to a relative strength of a recommendation/product match based on a confidence score that is derived from the weighted values. In one example, a number, or a bar, or some type of graphic can be displayed in a user interface that corresponds to a calculated confidence score and thereby indicates closeness or strength of a match a respective recommended product is for a user and the user's needs and desires.

For a uniqueness component of the confidence score, the selection and scoring service can implement a natural language analysis based on a collection of words per product for the products included in the identified product library. The analysis implemented may incorporate a case-insensitive n-gram search of indexed product data. Each BCV search, and in particular each desired feature/keyword BCV may be tokenized, have punctuations removed, and have stop words (i.e., “the”) removed or ignored as part of the analysis. A minimum of three characters may define a word and phrases enclosed within quotation marks may be matched as one word/phrase value that may be matched exactly as a combination of words within a quotation.

The collection of words is based on product data such as description, reviews, ingredients, ingredient call-outs, and other descriptive product text. The confidence scored may be calculate based on the following match factors: (1) number of words in a document; (2) number of unique words; (3) total number of words in a collection; and (4) number of rows that contain a word, words, or phrases. Each match factor may be assigned a different weight relative to the other factors.

At stage 262, the selection and scoring service can calculate a confidence score for each product with matches based on weighted values of the matches for a respective product.

A relevance score of zero means no similarity. If a word is present in many documents (product data from many products), it is likely to generate a lower score. On the other hand, if a word is rare or present in fewer documents (product data from a small number of products), the selection and scoring service will calculate a higher score. Confidence scores can be displayed in a recommendation module of the user interface along with reviewer-defined product ratings.

In stage 264, the selection and scoring service can transmit scored product results to the recommendation service. At stage 268, the recommendation service can generate instructions for displaying scored product results and provide the user interface with the instructions in stage 272.

In stage 276, scored product results can be displayed in the user interface based on recommendation instructions. In one example, the selection and scoring service can aggregate and average all of the star reviews of a product, thereby providing an average score out of 5 stars for each product, and display this average along with the product's confidence score. In some example versions of the recommendation services, users may filter recommended products by average rating, product type, and price information.

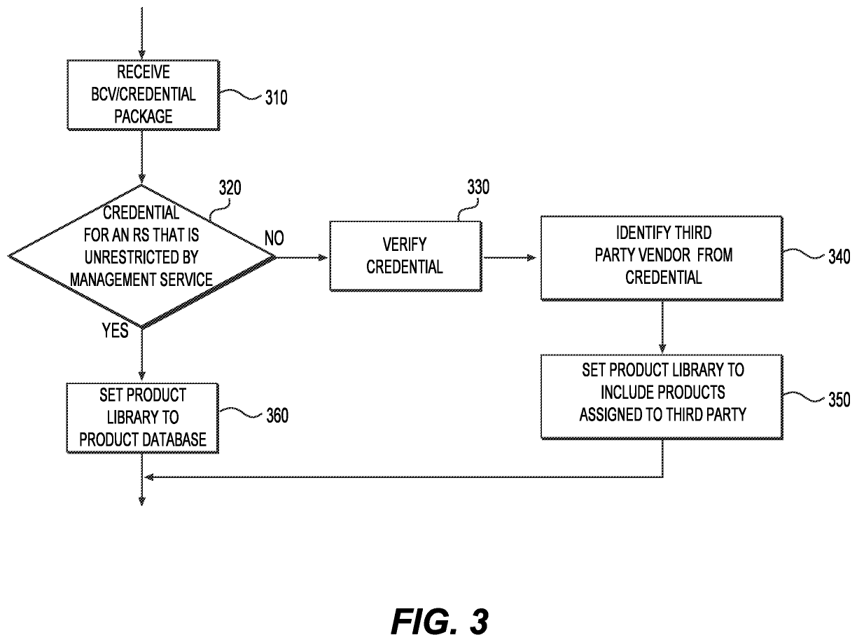

FIG. 3 is an algorithmic flowchart of an example method for identifying a product library based on a credential associated with a recommendation service.

At stage 310, a management service can receive BCV and credential package from a user device. In stage 320, the management service can determine if the credential is for a version of the recommendation service that is unrestricted by the management service. This means that the entirety of product data in the product database will be analyzed for matches with the BCVs.

In some examples, the version of the recommendation service may be embodied as a plug-in that can be inserted into existing code of a user interface of a brand or retailer, for example. Thus, third party beauty product providers may integrate the recommendation service into their respective user interfaces and enable the product matching features and capabilities of a system according to the present disclosure.

In stage 340, identify third party beauty product provider based on the credential and at stage 350, set a product library to include products in a product database that are assigned to the identified third-party beauty product provider.

Where it is determined that the version of the recommendation service does have unrestricted access to the product database, the product library may be set to the product database in stage 360.

An example implementing a version of a recommendation service for a third party beauty product provider follows. In this example, the management service determines that unrestricted access to the product database is not applicable and verifies a credential included in the package in stage 330. In one specific example, the recommendation service can be incorporated into on third party beauty product provider's website. Upon receiving BCVs through a user interface, the recommendation service may issue a call (e.g., an API call) to the backend which hosts the product database including product data for many third party beauty product providers including the provider on whose website the recommendation service is incorporated. In one example, an API call can be routed from the third party beauty product provider's website to a website supported, maintained, and managed by the backend, and thereby gain access to the product database.

As a result of the API call from the third party's website, beauty product recommendations specific to products for that third party will be returned from the backend to the recommendation service running on the third party's website. As a further result, products for the returned product recommendations will be displayed on the third party's website.

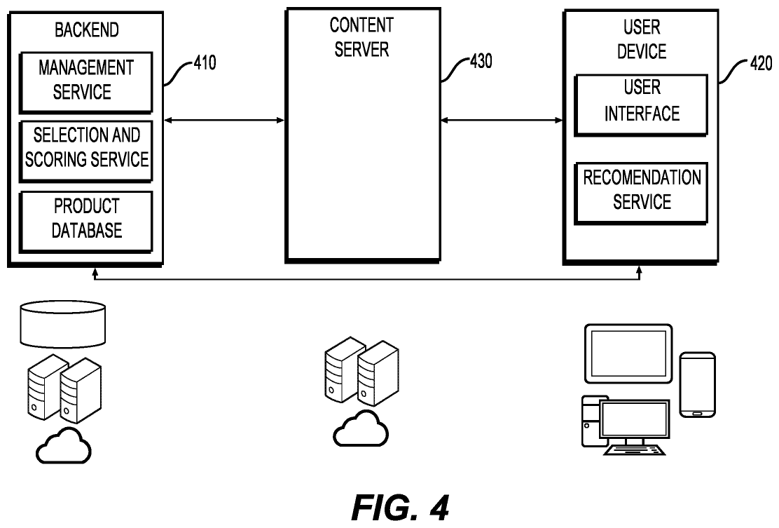

FIG. 4 is an illustration of exemplary system components for providing beauty product recommendations. As shown, the exemplary system components can include at least a backend 410 and a user device 420. In some examples the system components can include a content server 430. The backend 410 can be provided by a server, computing device, or network of multiple servers and/or computing devices, having one or more processors and memory stores. In one exampled the backend 410, along with management and scoring services, can include a product database. In other examples, the product database may be maintained on a server separate from backend server on which the above services execute and manage the operations of the backend.

The user device 420 can be any computing device, such as personal computer or a workstation, or more often, a smartphone, laptop, or a tablet. The user device 420 can include a non-transitory, computer-readable medium containing instructions executed by a processor. Example non-transitory, computer-readable mediums include RAM and ROM, disks, and other memory and storage accessible by a USB port, floppy drive, CD-ROM or DVD-ROM drive, and a flash drive, among others.

In those examples in which a content server is incorporated, the content server 430 can be one server, a computing device, or network of multiple servers and/or computing devices, having one or more processors and memory stores.

Communication between the portal application and the portal can be facilitated over a network, such as the internet.

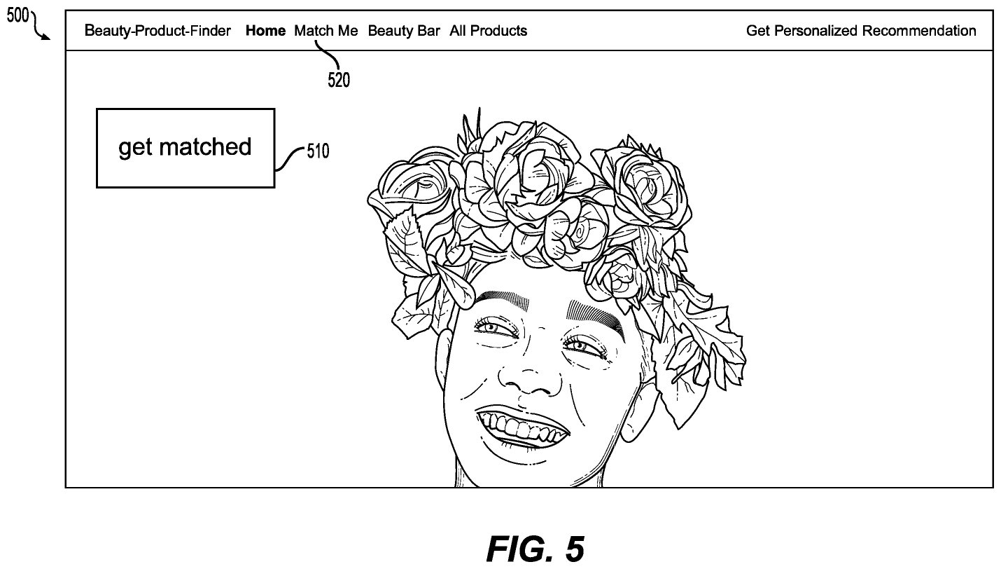

FIGS. 5-10 provide a walkthrough of the beauty product recommendation platform's web interface, demonstrating how the method is utilized during a user's journey on the web interface.

FIG. 5 illustrates an exemplary first interface 500 for accessing a recommendation service, according to an aspect of the present disclosure. A user can access a matching quiz using either a “Get Matched” option 510 or a “Match Me” option displayed in a navigation bar include by the interface 500.

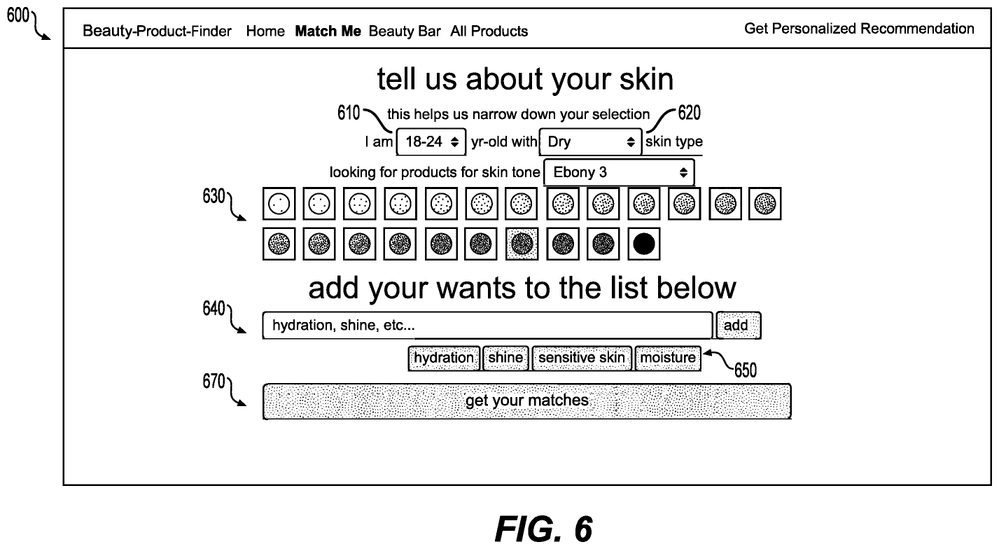

FIG. 6 illustrates an exemplary second interface 600 for a recommendation service, according to an aspect of the present disclosure.

In one example, a user may access the interface 600 after selecting one of the two options described above as being displayed on the first interface 500. On the second interface 600, a user can select values for certain beauty characteristic types included in the version of a recommendation service delivered by the second interface 600. In particular, a user can enter or select values an age range field option 610, a skin type field option 620, a skin tone field option 630, and a desired feature/keyword field option 640. In one example for the age range field option 610, a user may select from values including “13-17,” “18-24,” “25-34,” “35-44,” “45-54,” and “over 54.” For skin type field option 620, in one example, a user can select a value of one of “Normal,” “Oily,” “Dry,” or “Combination.” A value specified for the skin tone field option 630 can be provided by a user selecting from a plurality of different skin tone options displayed in the second interface 600 as shown. The desired feature/keyword field option 640 can be utilized by a user to input custom keyword values representing that user's specific wants and areas of focus they would like product recommendations for (i.e., hydration, shine, sensitive skin, etc.). Also included in the second interface 600 is an action option 670 (“Get your matches”) that can be selected in order to obtain recommendations based on the values input by the user above the action option 670.

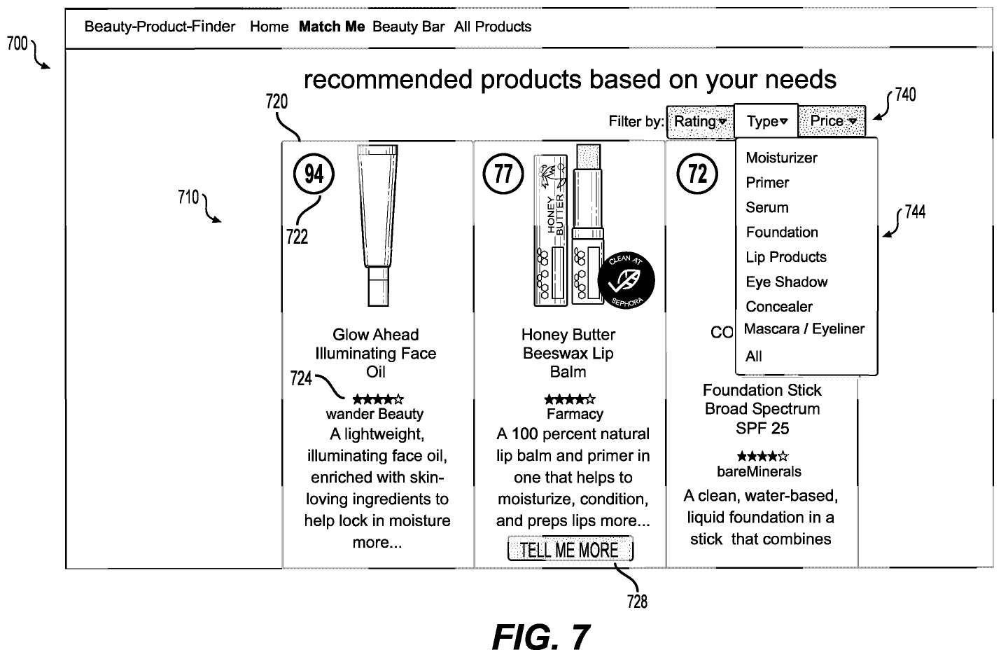

FIG. 7 illustrates an exemplary third interface 700 for a display scored product results 710 determined by a recommendation service. Each recommended product 720 may including a confidence score 722, a star rating 724, and a more information option 728 can be selected by a user. As discussed above, the product results 710 include product recommendations based on matches between the beauty characteristic values and product data in the form of product reviews from reviewers that may be of similar age range, skin type, skin tone, and skin wants as the user, as well as the overall descriptions of the products. Further, a user can be alerted to a strength of a recommendation/product match based on its confidence score 722. In addition, a user can filter scored product results by filter categories 740 that can include average rating, product type, and price. Each of these categories may be selected to reveal a drop-down box 744 of selectable filter values.

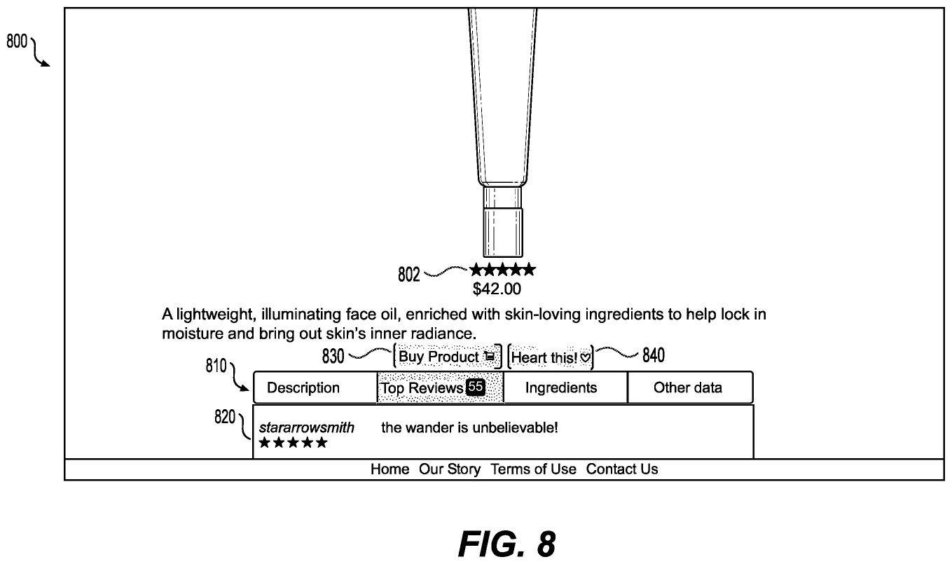

FIG. 8 illustrates an exemplary fourth interface 800 for viewing a single result selected from a product results interface such as the third interface 700 described above.

The fourth interface 800 can include product rating information 802, tabs 810 that can be selected to view a summary box 802 for product descriptions, product reviews, ingredient information, and any other specific information that contribute to the recommendation of a particular product. The user can elect to purchase the product using the buy option 830 button, or add the product to a list of favorites products by selecting a favorites option 840.

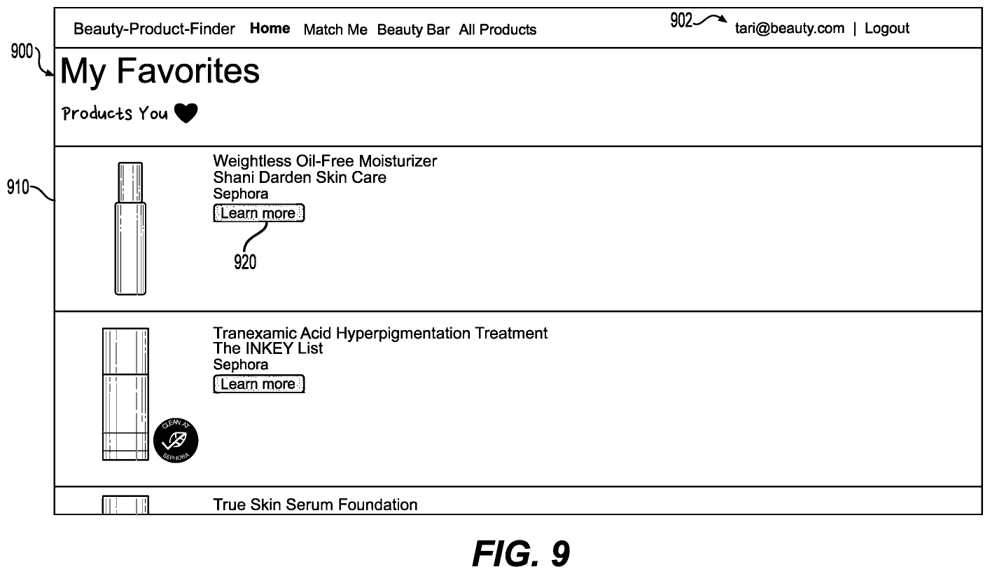

FIG. 9 illustrates an exemplary fifth interface 900 for viewing saved beauty products. If a user elects to save a product for later and add it to their list of favorites, they may be directed to a Sign In page, to sign into the user's account or sign up for a new account. Upon sign-in the fifth interface 900 may be displayed an include a list of saved products 910 associated with an account 902. A user can navigate to the fifth interface 900, as shown in FIG. 9, using a top navigation bar, and see the products that they have saved. Each saved product may be displayed with a learn more option 920 that will allow a user to access product detail page (fourth interface 800) for that product.

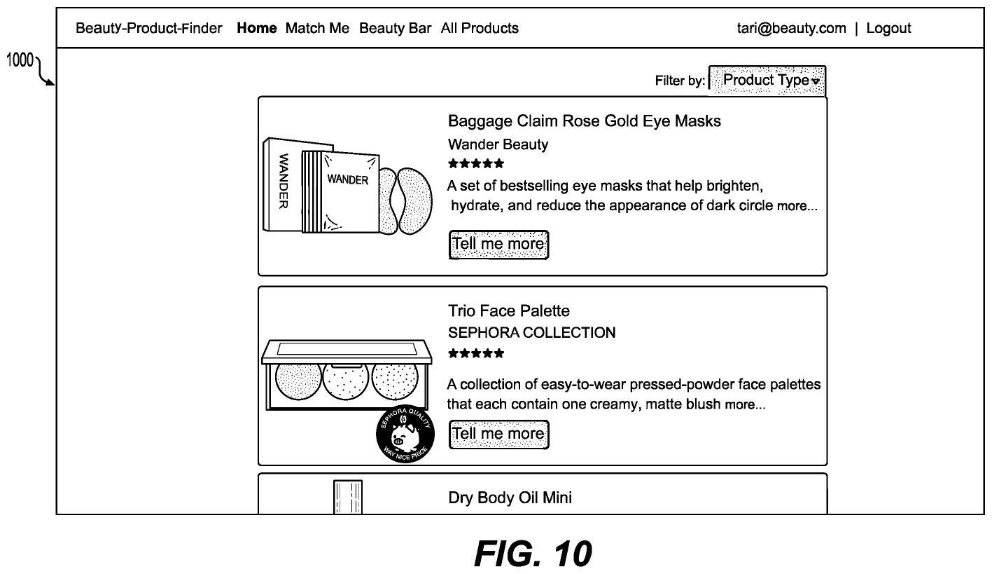

FIG. 10 illustrates an exemplary sixth interface 1000 for viewing beauty products. In one example, a user can elect to view all of the products available from a product database with the sixth interface shown in FIG. 10. This interface may not include specialized recommendations, but a user can filter displayed products based on rating, product type, and price. Products displayed in the sixth interface 1000 can be favorited so as to be added to a list of products associated with a user's account.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for providing beauty product recommendations, the method comprising:
receiving, with a server, beauty characteristic values (“BCVs”) for beauty characteristic types (“BCTs”) associated with a recommendation service;
identifying, with the server, product results from matches of BCVs for at least first and second BCTs with product user review information, the first and second BCTs selected from a group including skin tone, age, and skin type;
determining, with the server, confidence scores for products in final products results according to weighted values of matches; and
causing scored product results to be displayed in a user interface based on the confidence scores.

2. The method of claim 1, wherein determining the confidence scores includes assigning the weighted values to the matches based on degrees of correspondence between the product review information and the BCVs.

3. The method of claim 2, wherein assigning the weighted values is based on product information categories associated with the matches.

4. The method of claim 1, wherein the product user review information is included in a product library, and wherein the products included in the product library are determined based on a credential associated with the recommendation service.

5. The method of claim 4, wherein the product library is unrestricted and the products in the product library include products from a plurality of beauty product providers.

6. The method of claim 4, wherein the product library is restricted and the products in the product library include products from a single beauty product provider associated with the recommendation service.

7. The method of claim 6, further comprising receiving, with the server, an application programing interface call from the recommendation service associated with the BCVs.

8. A non-transitory, computer-readable medium containing instructions that, when executed by a hardware-based processor, performs stages for providing beauty product recommendations, the stages comprising:
receiving, with a server, beauty characteristic values (“BCVs”) for beauty characteristic types (“BCTs”) associated with a recommendation service;
identifying, with the server, product results from matches of BCVs for at least first and second BCTs with product user review information, the first and second BCTs selected from a group including skin tone, age, and skin type;
determining, with the server, confidence scores for products in final products results according to weighted values of matches; and
causing scored product results to be displayed in a user interface based on the confidence scores.

9. The non-transitory, computer-readable medium of claim 8, wherein determining the confidence score includes assigning the weighted values to the matches based on degrees of correspondence between the product review information and the BCVs the stages further comprising:

10. The non-transitory, computer-readable medium of claim 9, wherein assigning the weighted values is based on product information categories associated with the matches.

11. The non-transitory, computer-readable medium of claim 8, wherein the product user review information is included in a product library, and wherein the products included in the product library are determined based on a credential associated with the recommendation service.

12. The non-transitory, computer-readable medium of claim 11, wherein the product library is unrestricted and the products in the product library include products from a plurality of beauty product providers.

13. The non-transitory, computer-readable medium of claim 8, wherein the product library is restricted and the products in the product library include products from a single beauty product provider associated with the recommendation service.

14. The non-transitory, computer-readable medium of claim 8, the stages further comprising receiving, with the server, an application programing interface call from the recommendation service associated with the BCVs.

15. A system for providing beauty product recommendations, comprising:
a memory storage including a non-transitory, computer-readable medium comprising instructions; and
a computing device including a hardware-based processor that executes the instructions to carry out stages comprising:
receiving, with a server, beauty characteristic values (“BCVs”) for beauty characteristic types (“BCTs”) associated with a recommendation service;
identifying, with the server, product results from matches of BCVs for at least first and second BCTs with product user review information, the first and second BCTs selected from a group including skin tone, age, and skin type;
determining, with the server, confidence scores for products in final products results according to weighted values of matches; and
causing scored product results to be displayed in a user interface based on the confidence scores.

16. The system of claim 15, wherein determining the confidence score includes assigning the weighted values to the matches based on degrees of correspondence between the product review information and the BCVs.

17. The system of claim 16, wherein assigning the weighted values is based on product information categories associated with the matches.

18. The system of claim 15, wherein the product user review information is included in a product library, and wherein the products included in the product library are determined based on a credential associated with the recommendation service.

19. The system of claim 18, wherein the product library is unrestricted and the products in the product library include products from a plurality of beauty product providers.

20. The system of claim 18, wherein the product library is restricted and the products in the product library include products from a single beauty product provider associated with the recommendation service.
